(19) United States
(12) Patent Application Publication
(10) Pub. No.: US 2002/0116292 A1
(43) Pub. Date: Aug. 22, 2002

(54) Competitive on-line merchandising system

(75) Inventor: Tomer Palatin, Holon (IL)

Correspondence Address: DR. MARK FRIEMAN LTD, C/O BILL POLKINGHORN-DISCOVERY DISPATCH, 9003 FLORIN WAY, UPPER MARLBORO, MD, 20772, US

(73) Assignee: FLIP LTD

(21) Appl. No.: 09/785,487

(22) Filed: Feb. 20, 2001

(51) Int. Cl. G06F 17/60

(52) U.S. Cl. 705/27; 705/14; 705/400; 709/203

(57) ABSTRACT

A competitive merchandising system for conducting a transaction over the Internet, incorporating a game-like method, wherein people pay for a chance to obtain the right to purchase the merchandise at reduced prices. The disclosed system includes a plurality of user clients and at least one server capable of communicating with each user client. The server is capable of providing information including a plurality prices for the item for sale, making available a single price to the consumer in return for a fee, debiting an account belonging to the consumer for the fee, and further debiting the account for the single price if the item is purchased Also disclosed is a method including the steps of providing, by means of a server, information including information pertaining to a plurality of prices for the item for sale and revealing a single price from the plurality to the consumer in return for a fee and debiting an account belonging to the at least one consumer for the amount of the fee. Further disclosed is a second method including the steps of displaying, on a user client, information pertaining to an item for sale, wherein the information includes information regarding a plurality of prices for the item and remitting to an account of the party a fee in order to ascertain a single price from the plurality of fixed prices.

### FIELD AND BACKGROUND OF THE INVENTION

The present invention relates to a competitive merchandising system for conducting a transaction over an electronic network and, more particularly, to purchasing merchandise on the Internet, incorporating a game-like method, wherein people pay for a chance to acquire the right to purchase the merchandise at reduced prices. These reduced prices appear to be hidden in selected areas within a graphical user interface.

Retailing over the Internet is gaining popularity providing customers with both the convenience of remaining at home while shopping, in addition to almost endless variety of selection of goods. A preferred means of payment is by credit card or by establishing an account with the retailer. However, because of security reasons there has been a great reluctance of the users to transmit credit card account information over the Internet. Security over the Internet has improved over the years due to numerous inventions, which deal with these security issues. U.S. Pat. No. 6,047,268 to Rich teaches just one approach. In it he deals with transactions for the purchase of “soft” goods, i.e., information, software and other material available in electronic form that can be delivered in real time to a user's client device. Such transactions can also be for the purchase of conventional “hard” goods, where the purchased merchandise is delivered off-line. Conventional on-line payment options generally involve the use of credit cards wherein the user provides his or her credit card number on-line or off-line to the merchant provider, in order to pay for the “hard” or “soft” purchase to be delivered on-line or off-line.

Where the transactions involve a relatively small cost, for example $10 or less, the credit card system of payment is generally considered too expensive. Further, the credit card payment system excludes potential customers who do not have a credit card, or those who do but do not “trust” either providing their credit card number on-line, or do not want to use their credit card for such purchases. Rich suggests that it would be advantageous, therefore, that some trusted transaction intermediary perform the functions of authenticating a user on the WWW and authorizing the transaction. Once such a transaction intermediary authenticates the user and authorizes the transaction, the merchant is alerted to provide the goods or services, which are the subject of the transaction, and an account associated with the user is billed for the transaction amount. Advantageously, once the user has registered with the transaction intermediary, no sensitive billing information, such as a credit card number, needs to be sent to the merchant.

As an additional example of a means of dealing with payment over the Internet U.S. Pat No. 5,845,267 to Ronen teaches a system and method for performing centralized billing for transactions conducted by a user on a terminal connected on an Intranet with an Internet Service Provider (ISP) connected to the Internet. A Firewall Gateway interconnects the Intranet and the Internet and removes the terminal's IP address from packets transmitted by the user's terminal to the ISP on the Internet. A Session Manager stores in a database) the associations between the IP address of the user's terminal and the user's identity, and between the IP address and the Connection ID of the connection established between the Firewall Gateway and the ISP for an ongoing transaction between the user and the ISP. A Billing Platform receives a signal indicating the cost of the transaction and the Connection ID associated with the transaction from the ISP. The Billing Platform then accesses the database of the Session Manager to determine the identity of the user from the Connection ID and an account of the identified user is retrieved in a database associated with the Billing Platform. The account is then billed for the cost of the transaction and forwarded to a billing entity for billing to the user in accordance with the user's pre-established billing mechanism.

Gambling has always been a popular means for gaining people's attention especially if the stakes are high and the bet is relatively low.

Governmental lotteries and analogous private gaming activities have become increasingly popular in many areas of the United States and of the world. Similar games and contests are often used by private industrial companies for promotional purposes. Particularly favored in these contexts are so-called “instant-win” tickets, in which an opaque latex covering obscures symbols or indicia. To play the game presented on such a ticket, a player removes (“scratches off”) the latex covering to reveal the hidden symbols. By doing so, the player is able to discern whether he or she has won a prize associated with the game played on the ticket.

U.S. Pat. Nos. 5,532,046 to Rich, et al. and 5,569,512 to Brawner, et al., describe structures of various instant-win tickets. As disclosed in the Rich, et al. patent, for example, foil or coatings including metallic particles may be used in the tickets to deter candling, a process whereby unscrupulous players attempt to view the hidden symbols by examining the tickets before a light source. The Brawner, et al. patent, by contrast, discusses masking the boundaries of the scratch-off covering on a ticket to make them more difficult to locate and thereby inhibit improper removal of the covering.

Among the advantages of instant-win tickets are their ability to provide immediate gratification to the player. Unlike holders of tickets for scheduled prize drawings, for example, who must await completion of the drawings to determine whether they have won any prize, purchasers of instant-win tickets are able to discern the extent of their successful play immediately following their acquiring the tickets.

The present invention teaches a novel means for purchasing merchandise over the Internet. It combines a purchase with a gamble giving customers an opportunity to obtain the right to purchase a selected item at a greatly reduced price by risking only a small portion of the purchase price.

### SUMMARY OF THE INVENTION

According to one aspect of the present invention, there is provided a system for offering at least one item for sale to at least one consumer operating at least one user client belonging to a plurality of user clients. The system comprises; (a) the plurality of user clients, each of the user clients designed and configured to operate a graphical user interface, the graphical user interface designed and configured for offering the at least one item for sale; (b) at least one server capable of communicating with each user client of the plurality of user clients, the server designed and configured for: (i) providing information pertaining to the at least one item for sale to a specific user client belonging to the plurality of user clients, wherein the information includes a plurality of fixed prices for the at least one item for sale, a single price from the plurality of fixed prices being made available to the consumer in return for a fee; (ii) debiting an account belonging to the at least one consumer for the amount of the fee; (iii) further debiting the account for the single price if the consumer elects to purchase the item for sale.

According to another aspect of the present invention, there is provided a method for offering at least one item for sale to at least one consumer operating at least one user client belonging to a plurality of user clients. The method comprises the steps of: (a) providing, by means of a server, information pertaining to the at least one item for sale to the user client belonging to the plurality of user clients, wherein the information including information pertaining to a plurality of fixed prices for the at least one item for sale; (b) revealing a single price from the plurality of fixed prices to the consumer in return for a fee; and (c) debiting an account belonging to the at least one consumer for the amount of the fee.

According to yet another aspect of the present invention, there is provided a method of purchasing at least one item for sale from a party. The method comprises the steps of: (a) displaying, on a user client, information pertaining to the at least one item for sale, wherein the information includes information regarding a plurality of fixed prices for the at least one item for sale, and (b) remitting to an account of the party a fee in order to ascertain a single price from the plurality of fixed prices.

According to yet another aspect of the present invention, there is provided a system for offering at least one item for sale to at least one consumer operating at least one user client belonging to a plurality of user clients. the system includes at least one server capable of communicating with each user client of the plurality of user clients. The server is designed and configured for: (a) providing information pertaining to the at least one item for sale to a specific user client belonging to said plurality of user clients, wherein said information includes a plurality of fixed prices for the at least one item for sale, a single price from said plurality of fixed prices being made available to the consumer in return for a fee, (b) debiting an account belonging to the at least one consumer for the amount of the fee, (c) further debiting said account for said single price if the consumer elects to purchase the item for sale.

According to further features in preferred embodiments of the invention described bellow, the plurality of fixed prices is selected from the group consisting of identical prices and varied prices.

According to still further features in the described preferred embodiments the at least one server is further designed and configured for providing a list displayed in the graphical user interface, the list including all of the plurality of fixed prices.

According to still further features in the described preferred embodiments the server is further designed and configured for: (iv) allowing the consumer to cancel the sale.

According to still further features in the described preferred embodiments the server is further designed and configured for: (v) further debiting the account for an additional fee if the consumer elects to have an alternate single price made available.

According to still further features in the described preferred embodiments the method includes the additional step of further debiting the account for the single price in order to effect a purchase of the item for sale.

According to still further features in the described preferred embodiments the method includes at least one additional step selected from the group consisting of: (d) providing a list of the plurality of fixed prices for the at least one item for sale to the consumer for display on a user client; (e) allowing the consumer to cancel the sale; (f) permitting the consumer to request the display of an additional fixed price belonging to the plurality of fixed prices of the at least one item for sale and debiting the account for an additional fee.

According to still further features in the described preferred embodiments the method includes the additional step of further remitting to the account the single price in order to purchase the item for sale.

According to still further features in the described preferred embodiments the method includes at least one additional step selected from the group consisting of (d) canceling the sale and remitting an additional fee to the account in order to ascertain an additional fixed price belonging to the plurality of fixed prices.

The present invention successfully addresses the shortcomings of the presently known configurations by providing a system and method for offering at least one item for sale to at least one consumer operating at least one user client belonging to a plurality of user clients with the possibility of making a purchase for a reduced price.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 depicts a system according to the present invention;

FIG. 2 depicts a portion of a graphical user interface according to the present invention;

FIG. 3 depicts a portion of a graphical user interface according to the present invention;

FIG. 4 depicts a portion of a graphical user interface according to the present invention in which areas of the screen corresponding to prices are presented to a consumer;

FIG. 5 depicts a portion of a graphical user interface according to the present invention, displayed are a randomly chosen price and two areas of the screen corresponding to purchasing the item at the randomly selected price, or obtaining an additional price;

FIG. 6 depicts a portion of a graphical user interface according to the present invention, in which two areas of the screen offer the options of purchasing the item or canceling the purchase;

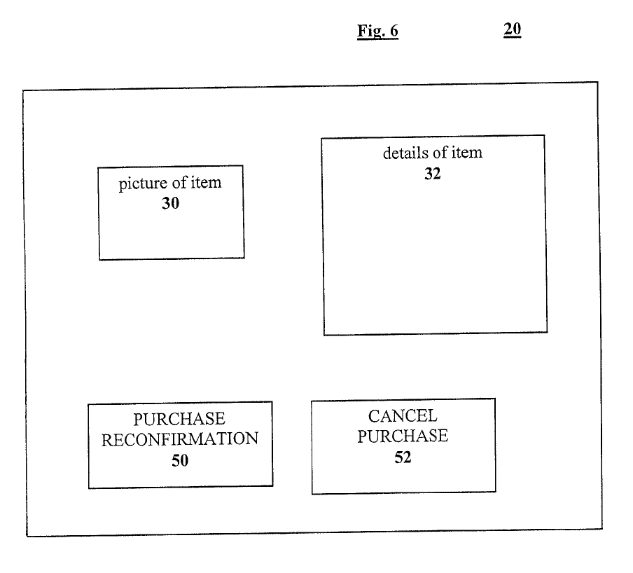

FIG. 7 is a flow diagram illustrating steps in a method according to the present invention;

FIG. 8 is a flow diagram illustrating steps in a method according to the present invention.

### DESCRIPTION OF THE PREFERRED EMBODIMENTS

The present invention is of a system and method for offering at least one item for sale to at least one consumer operating at least one user client belonging to a plurality of user clients, which can be used to combine a purchase with a gamble on a lower price for a fee. Specifically, the present invention can be used to purchase an item while simultaneously offering a consumer a gamble with immediate gratification. The prize in the gamble is a reduced price on the item to be purchased.

The principles and operation of systems and methods according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase “user client” generally refers to a computer and includes, but is not limited to, personal computers (PC) having an operating system such as DOS, Windows™ or Linux; Macintosh™ computers; computers having JAVA™-OS as the operating system; and graphical workstations such as the computers of Sun Microsystems™ and Silicon Graphics™, and other companies having some version of UNIX operating system such as AIX™ or SOLARIS™ of Sun Microsystems™; or any other known and available operating systems; personal digital assistants (PDA), cellular telephones having computer capabilities and Web TVs.

For purposes of this specification and the accompanying claims, the term “Windows™” includes but is not limited to Windows 95™ Windows 2000™ Windows 3.x™ in which “x” is an integer such as “1”, Windows NT™, Windows 98™, Windows CE™ and any upgraded versions of these operating systems by Microsoft Corp (USA) and /or window managers for the graphical X Windows system for UNIX based operating systems and/or its variants such as Linux.

For purposes of this specification and the accompanying claims, the term “server” refers to any computing machine capable of exchanging data with at least one other computing machine. A single server may comprise an individual computing machine or a plurality of such machines acting in concert to perform a function requested by at least one other computing machine.

A non-limiting example of a purchase of an item for sale on the Internet according to one embodiment of the present invention is described herein below.

Prior to any purchasing or paying a fee a consumer must establish an account with the server. The means for establishing an account is known to those ordinarily skilled in the art of Internet commerce. Alternately or additionally, an established credit cart account belonging to a consumer may be employed for purposes of practicing the methods of the present invention.

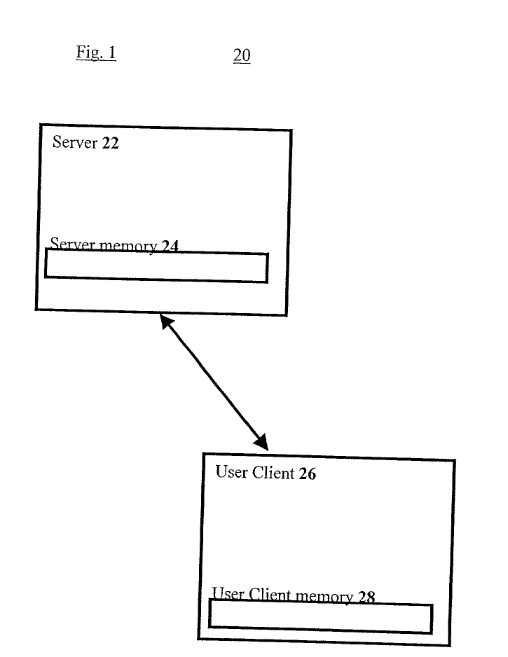

Referring now to the drawings, FIG. 1 is of a system 20 for offering at least one item for sale to at least one consumer operating at least one user client 26 belonging to a plurality of user clients. Each user client 26 contains at least one memory device 28. System 20 includes the plurality of user clients 26 (only one is shown). Each user client 26 is designed and configured to operate a graphical user interface. The graphical user interface is designed and configured for offering the at least one item for sale. System 20 further includes at least one server 22 capable of communicating with each user client of the plurality of user clients. Server 22 includes at least one memory device 24 and is designed and configured for performing a variety of functions associated with selling the at least one item for sale. One of these functions includes providing information pertaining to the at least one item for sale to user client 26, wherein the information includes a plurality of fixed prices for the item for sale. According to system 20, a single price from the plurality of fixed prices is made available to the consumer in return for a fee. Server 22 further functions to debit an account belonging to the at least one consumer for the amount of the fee and, alternately or additionally, to further debit the account for the single price if the consumer elects to purchase the item for sale. According to alternate preferred embodiments of the present invention, system 20 for offering at least one item for sale to at least one consumer operating at least one user client belonging to a plurality of user clients includes at least one server 22 capable of communicating with each user client of the plurality of user clients. Server 22 is designed and configured as described hereinabove. The plurality of fixed prices may include some identical prices and some varied prices.

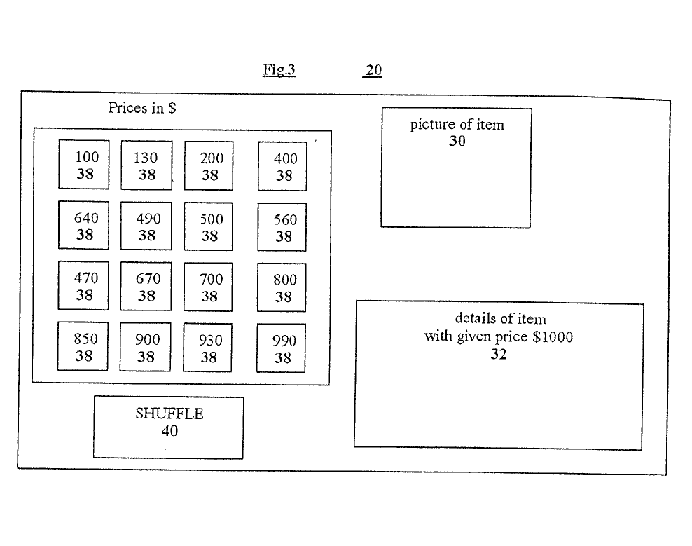

In some cases, server 22 is further designed and configured for providing a list displayed in the graphical user interface, the list including all of the plurality of fixed prices 38 (FIG. 3). Alternately or additionally, server 22 is designed and configured for allowing the consumer to cancel a sale. In some variations of the game played using system 20, server 22 is further designed and configured for further debiting the account for an additional fee if the consumer elects to have an alternate single price 38 made available.

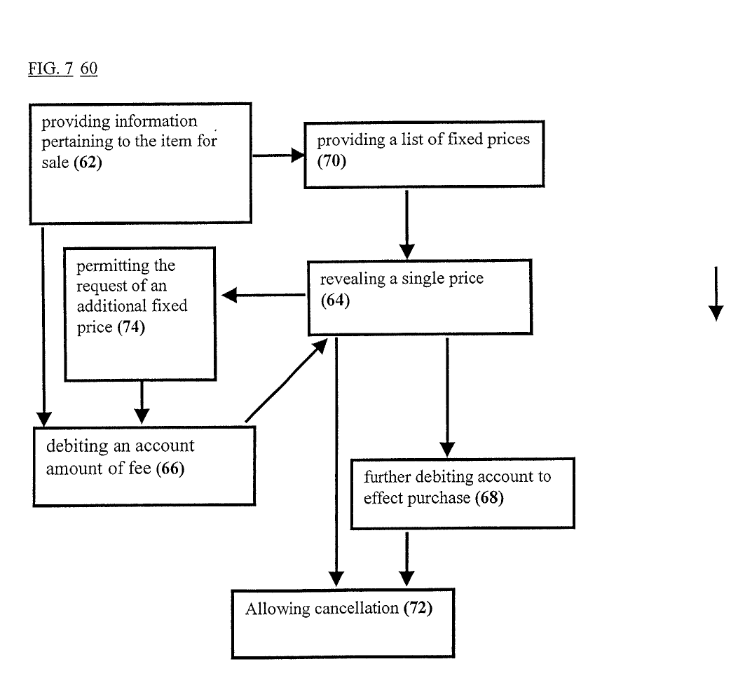

The present invention is further embodied by a method 60 (FIG. 7) for offering at least one item for sale to at least one consumer operating at least one user client belonging to a plurality of user clients. Method 60 includes the step of providing 62, by means of a server, information pertaining to the at least one item for sale to the user client. The provided information includes information pertaining to a plurality of fixed prices for the at least one item for sale. Method 60 further includes the step of revealing 64 a single price from the plurality of fixed prices to the consumer in return for a fee and the step of debiting 66 an account belonging to the at least one consumer for the amount of the fee. In some cases method 60 may include the additional step of further debiting 68 the account for the single price in order to effect a purchase of the item for sale.

Alternately or additionally, method 60 includes at least one additional step which may include, but is not limited to providing 70 a list of the plurality of fixed prices for the at least one item for sale to the consumer for display on a user client or allowing 72 the consumer to cancel the sale or permitting 74 the consumer to request the display of an additional fixed price belonging to the plurality of fixed prices of the at least one item for sale and debiting the account for an additional fee.

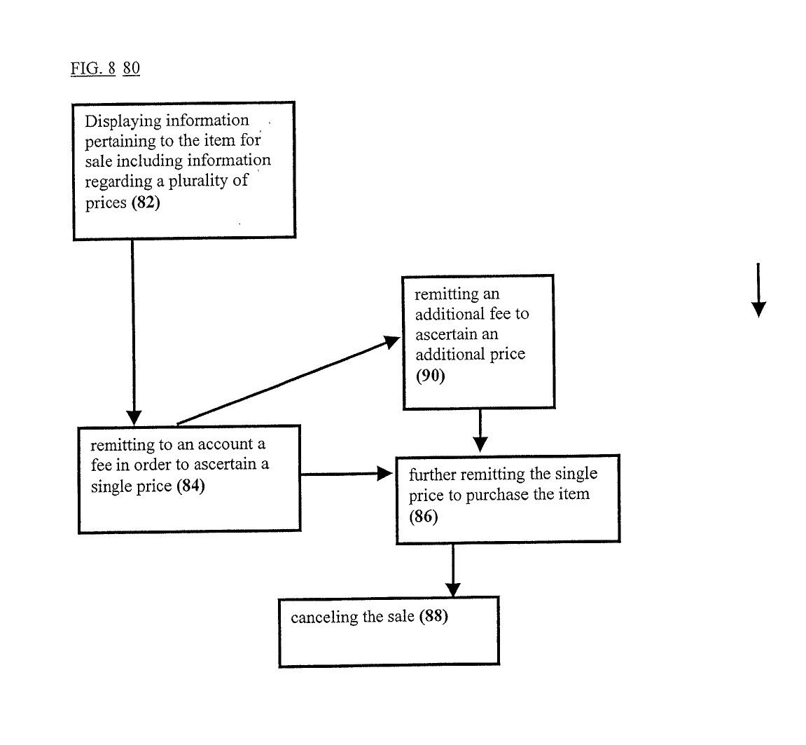

The present invention is further embodied by a second method 80 (FIG. 8) of purchasing at least one item for sale from a party. Method 80 includes the step of displaying 82, on a user client, information pertaining to the at least one item for sale. The displayed information includes information regarding a plurality of fixed prices for the at least one item for sale. Method 80 further includes the step of remitting 84 to an account of the party a fee in order to ascertain a single price from the plurality of fixed prices.

In many cases, method 80 has as its endpoint the additional step of further remitting 86 to the account the single price in order to purchase the item for sale. Alternately, or additionally, method 80 may include additional steps such as, for example, canceling 88 the sale and remitting 90 an additional fee to the account in order to ascertain an additional fixed price belonging to the plurality of fixed prices.

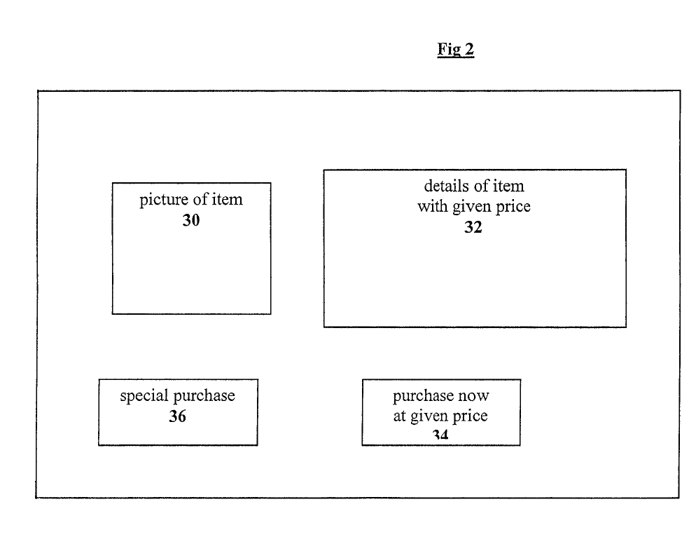

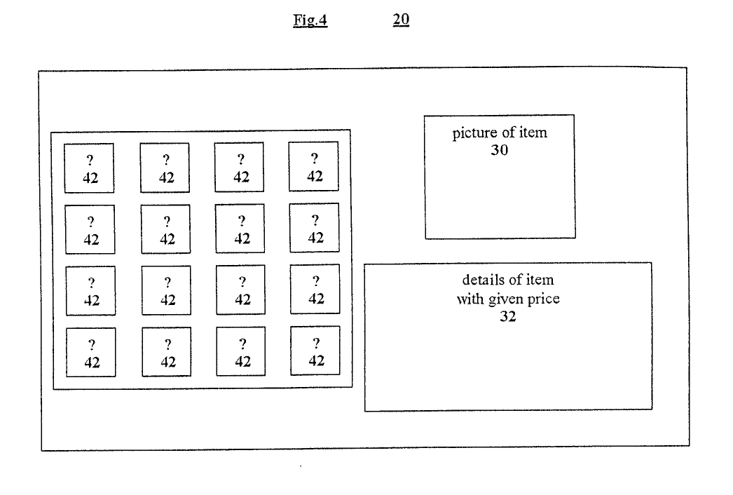

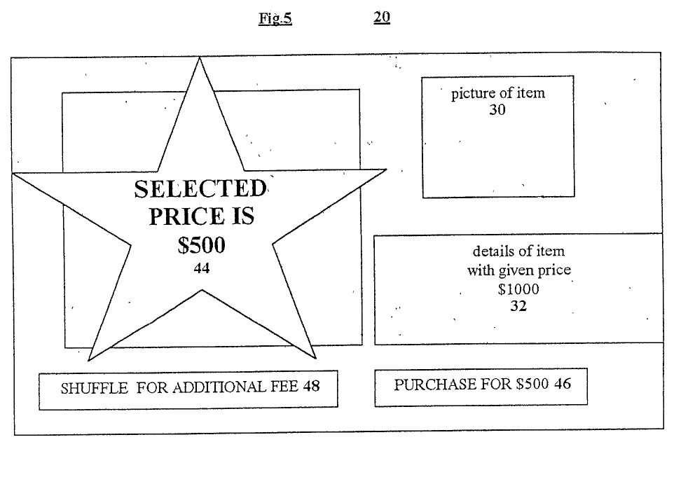

As an illustrative example of an embodiment of systems 20 and methods 60 and 80 of the present invention, an example of an item offered for sale is presented. FIG. 2 illustrates a portion of a graphical user interface (GUI), for example a Web browser (e.g. Netscape, Internet Explorer or another program with comparable functionality). Data displayed in the GUI includes, in this example, a picture 30 of an item for sale; a written detailed 32 description including a given price. In this example the given price is the manufacturer's suggested retail price, although it might be any price. Icons in the GUI offer the consumer at least the options of purchasing 34 at the given price or a special purchase 36 according to the present invention. For the sake of the example, it is presumed that the consumer has elected special purchase 36. In response to this decision, the consumer may be shown, for example, a GUI containing the elements illustrated in FIG. 3. These might include, for example, picture 30, written description 32, and a list of prices 38, each of prices 38, being displayed in a location within a matrix. According to some embodiments of the invention, list of prices 38 reveals to the consumer the probability (i.e. odds) of receiving a soecific price 38 if the consumer chooses to play the game. It is an important feature of the invention that at least some of prices 38 are lower than a price given in description 32. This provides an incentive for the consumer to play. In the pictured example, all of prices 38 are lower than the suggested retail price, although some are close to that price. At this point, the consumer has not yet begun to play the game offered by system 20. Assuming that the consumer selects the SHUFFLE ICON 40, play will commence. At this point the consumer is shown a matrix of areas 42 (FIG. 4), each area 42 corresponding to one of prices 38 which are now “hidden”. According to alternate embodiments of the invention, prices 38 may be stored in either server memory 24 or user client memory 28. In either case, selection of one of areas 42 will “reveal” a selected price 44 (FIG. 5), pictured here as a large star shaped icon. In return for revealing selected price 44, the consumer is assessed a fee which is debited 66 from an account of the consumer and remitted 84 to an account of a party operating server 22. In the current example, the selected price is 500$ and the suggested retail price was 1000$. This means that, assuming the fee to play was less than 500$, the consumer is likely to select “PURCHASE FOR 500$” 46. If, however, the selected price had been 990$, and the fee for revealing a price is 10$, the consumer might be tempted to select “SHUFFLE FOR ADDITIONAL FEE” 48 which would result in execution of method steps 74 and 90 as detailed hereinabove. According to some embodiments of the invention, the consumer may have the additional option of canceling 52 or confirming 50 the purchase.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for offering at least one item for sale to at least one consumer operating at least one user client belonging to a plurality of user clients, the system comprising;
(a) the plurality of user clients, each of the user clients designed and configured to operate a graphical user interface, said graphical user interface designed and configured for offering the at least one item for sale;
(b) at least one server capable of communicating with each user client of the plurality of user clients, said server designed and configured for:
(i) providing information pertaining to the at least one item for sale to a specific user client belonging to said plurality of user clients, wherein said information includes a plurality of fixed prices for the at least one item for sale, a single price from said plurality of fixed prices being made available to the consumer in return for a fee;
(ii) debiting an account belonging to the at least one consumer for the amount of the fee;
(iii) further debiting said account for said single price if the consumer elects to purchase the item for sale.

2. The system of claim 1, wherein said plurality of fixed prices is selected from the group consisting of identical prices and varied prices.

3. The system of claim 2, said at least one server is further designed and configured for providing a list displayed in said graphical user interface, said list including all of said plurality of fixed prices.

4. The system of claim 2, wherein said server is further designed and configured for:
(iv) allowing the consumer to cancel the sale.

5. The system of claim 2, wherein said server is further designed and configured for:
(v) further debiting said account for an additional fee if the consumer elects to have an alternate single price made available.

6. A method for offering at least one item for sale to at least one consumer operating at least one user client belonging to a plurality of user clients, the method comprising the steps of:
(a) providing, by means of a server, information pertaining to the at least one item for sale to the user client belonging to the plurality of user clients, wherein said information including information pertaining to a plurality of fixed prices for the at least one item for sale;
(b) revealing a single price from said plurality of fixed prices to the consumer in return for a fee; and
(c) debiting an account belonging to the at least one consumer for the amount of said fee.

7. The method of claim 6, comprising the additional step of:
(d) further debiting said account for said single price in order to effect a purchase of the item for sale.

8. The method of claim 6, wherein said plurality of fixed prices are selected from the group of identical and varied prices.

9. The method of claim 8, comprising at least one additional step selected from the group consisting of:
(d) providing a list of said plurality of fixed prices for the at least one item for sale to the consumer for display on a user client;
(e) allowing the consumer to cancel the sale;
(f) permitting the consumer to request the display of an additional fixed price belonging to said plurality of fixed prices of the at least one item for sale and debiting said account for an additional fee.

10. A method of purchasing at least one item for sale from a party, the method comprising the steps of:
(a) displaying, on a user client, information pertaining to the at least one item for sale, wherein said information includes information regarding a plurality of fixed prices for the at least one item for sale;
(b) remitting to an account of the party a fee in order to ascertain a single price from said plurality of fixed prices.

11. The method of claim 10, comprising the additional step of:
(c) further remitting to said account said single price in order to purchase the item for sale.

12. The method of claim 10, wherein said plurality of fixed prices are selected from the group of identical and varied prices.

13. The method of claim 11, including at least one additional step selected from the group consisting of:
(d) canceling the sale;
(e) remitting an additional fee to said account in order to ascertain an additional fixed price belonging to said plurality of fixed prices.

14. A system for offering at least one item for sale to at least one consumer operating at least one user client belonging to a plurality of user clients, the system comprising;
at least one server capable of communicating with each user client of the plurality of user clients, said server designed and configured for:
(a) providing information pertaining to the at least one item for sale to a specific user client belonging to said plurality of user clients, wherein said information includes a plurality of fixed prices for the at least one item for sale, a single price from said plurality of fixed prices being made available to the consumer in return for a fee;
(b) debiting an account belonging to the at least one consumer for the amount of the fee;
(c) further debiting said account for said single price if the consumer elects to purchase the item for sale.

15. The system of claim 14, wherein said plurality of fixed prices is selected from the group consisting of identical prices and varied prices.

16. The system of claim 15, wherein said at least one server is further designed and configured for providing a list displayed in said graphical user interface, said list including all of said plurality of fixed prices.

17. The system of claim 15, wherein said server is further designed and configured for:
(d) allowing the consumer to cancel the sale.

18. The system of claim 15, wherein said server is further designed and configured for:
(e) further debiting said account for an additional fee if the consumer elects to have an alternate single price made available.
